(19) United States
(12) Patent Application Publication
(10) Pub. No.: US 2016/0191587 A1
(43) Pub. Date: Jun. 30, 2016

(54) METHOD, SYSTEM, AND RECORDING MEDIUM FOR PROVIDING INFORMATIONAL DATA FOR VOICE CONTENT

(71) Applicant: NAVER Corporation, Seongnam-si (KR)

(72) Inventor: Donghyun Gu, Seongnam-si (KR)

(21) Appl. No.: 14/950,139

(22) Filed: Nov. 24, 2015

(30) Foreign Application Priority Data
Dec. 30, 2014 (KR) 10-2014-0193530

(51) Int. Cl. H04L 29/06; H04L 29/08

(52) U.S. Cl. CPC H04L 65/4084; H04L 67/2804; H04L 67/42

(57) ABSTRACT

A voice informational data providing method for providing voice informational data over a network includes registering, by a processor of the computer to a database, voice informational data that is content produced in a voice form, and selecting, by the processor, voice informational data about at least one piece of content from the registered voice informational data, and providing the selected voice informational data to a publisher server over the network based on a playback condition set to the publisher server.

### CROSS-REFERENCE TO RELATED APPLICATION

This application claims priority from and the benefit of Korean Patent Application No. 10-2014-0193530, filed on Dec. 30, 2014, the disclosure of which is incorporated herein in its entirety by reference.

### BACKGROUND

1. Field

Example embodiments of the present invention relate to a platform that provides network-based informational data.

2. Description of the Background

A mobile terminal, for example, a smartphone, a tablet, and a wearable computer, performs various functionalities, for example, a camera, a game, and navigation, in addition to the functionality as a communication device for mobile communication and wireless Internet.

The functional diversification of the mobile terminal has a close relation with the developments in multimedia technology. Currently, the mobile terminal serves as an alarm clock with an embedded timer, serves as a mobile video/sound source player by outputting a high quality image and a high quality sound source, and also serves as a location guide device for vehicles and/or walking with a global positioning system (GPS).

Meanwhile, a content providing model that inserts a content object in a webpage is widely used as a method to make revenues from the webpage.

Further, with the recent increasing use of a mobile terminal and developments in content servicing technology using the mobile terminal, the content providing model is also widely used on a mobile webpage.

### SUMMARY

Some example embodiments of the present invention provide a method, a system, and/or a non-transitory computer-readable medium that provide voice informational data for voice content by constructing a platform for content in which a voice is used as a material.

Some example embodiments also provide a method, a system, and/or a non-transitory computer-readable medium that provide a voice informational data suitable for a real-time service environment.

Some example embodiments also provide a method, a system, and/or a non-transitory computer-readable medium that control a transmission of voice informational data based on a content consumption environment of a user.

According to at least one example embodiment, there is provided a voice informational data providing method configured in a computer to provide voice informational data over a network, the method including registering, by a processor of the computer to a database, voice informational data that is content produced in a voice form, and selecting, by the processor, voice informational data about at least one piece of content from the registered voice informational data, and providing the selected voice informational data to a publisher server over the network based on a playback condition set to the publisher server.

The publisher server may be configured to provide a medium that provides a network-based service to a terminal of a user, and providing to the publisher server may include providing the selected voice informational data to the terminal of the user through the medium.

Providing to the publisher server may include providing the selected voice informational data based on the playback condition in response to the publisher server selecting at least one playback condition from among a playback time section of the selected voice informational data, a playback time of the selected voice informational data, and a targeting element about a user to receive the selected voice informational data.

Providing to the publisher server may include determining a ranking index for each registered voice informational data based on a bid amount for a playback time and a basic playback time of the registered voice informational data, and determining voice informational data to be provided to the publisher server from the registered voice informational data based on the ranking index.

Determining of the ranking index may include determining the ranking index by applying a weight according to the playback time to the bid amount.

Providing to the publisher server may include collecting user information for a targeting in association with the user, and selecting voice informational data of content that matches the collected user information based on a targeting element set to the voice informational data.

Providing to the publisher server may include verifying an output environment associated with the selected voice informational data in a terminal used by the user, and controlling whether to transmit the selected voice informational data to the publisher server based on the output environment.

Verifying of the output environment may include verifying at least one of a connection between the terminal and an audio output device and an execution of an application set to the voice informational data at the terminal.

Controlling may include controlling whether to transmit the selected voice informational data to the publisher server based on an exposure frequency capacity set to the selected voice informational data.

The voice informational data providing method may further include calculating cost based on an amount of time in which the selected voice informational data is played back at a terminal of the user through a medium provided from the publisher server.

Calculating of the cost may include calculating the cost by applying a weight according to the amount of time to a bid amount for a basic playback time of the selected voice informational data.

Revenues gained by playing back the selected voice informational data at a terminal of the user through the publisher server may be shared with a publisher that provides the publisher server.

According to at least one example embodiment, there is provided a voice informational data exposure method executed in a computer to expose voice informational data over a network, the method including setting, by a processor of the computer with respect to a network-based service that is provided to a user, at least one playback condition among a playback time section of voice informational data that is content produced in a voice form, a playback time of the voice informational data, and a targeting element about the user to receive the voice informational data, and receiving, by the processor, voice informational data about at least one piece of content from voice informational data registered to a platform server from the platform server over the network based on the playback condition, and providing the received voice informational data to a terminal of the user.

According to at least one example embodiment, there is provided a voice informational data providing system of a platform server to provide voice informational data over a network, the system including at least one processor, wherein the at least one processor includes a registerer configured to register voice informational data that is content produced in a voice form, and a provider configured to select voice informational data about at least one piece of content from the registered voice informational data, and to provide the selected voice informational data to a publisher server over the network based on a playback condition set to the publisher server.

The publisher server may be configured to provide a medium that provides a network-based service to a user to a terminal of the user, and the provider may be further configured to provide the selected voice informational data to the terminal of the user through the medium.

The provider may be further configured to provide the selected voice informational data based on the playback condition in response to the publisher server selecting at least one playback condition from among a playback time section of the selected voice informational data, a playback time of the selected voice informational data, and a targeting element about a user to receive the selected voice informational data.

The provider may be further configured to determine a ranking index for each registered voice informational data based on a bid amount for a playback time and a basic playback time of the registered voice informational data, and to determine voice informational data to be provided to the publisher server from the registered voice informational data based on the ranking index.

The provider may be further configured to verify an output environment associated with the selected voice informational data in a terminal used by the user, and to control whether to transmit the selected voice informational data to the publisher server based on the output environment.

Revenues gained by playing back the selected voice informational data at a terminal of the user through the publisher server may be shared with a publisher that provides the publisher server.

The revenues may be calculated based on an amount of time in which the selected voice informational data is played back at the terminal of the user through the medium provided from the publisher server and a bid amount for a basic playback time.

It is to be understood that both the foregoing general description and the following detailed description are explanatory and are intended to provide further explanation of the example embodiments as claimed.

According to at least one example embodiment, it is possible to apply voice informational data to the overall network-based service through a new type of content providing model by constructing a platform for content in which a voice is used as a material and by providing the voice informational data for voice content.

Also, according to at least one example embodiment, since a streaming service that provides voice-based contents provides voice typed additional content, it is possible to further activate a voice content market that is distinguished from existing services.

Also, according to at least one example embodiment, it is possible to enhance a transmission efficiency of additional content, to decrease a user's fatigue coming from consuming the additional content, and to increase the reliability between the user and a provider of the additional content by targeting and controlling a transmission of voice typed additional content based on a content consumption environment of the user.

### BRIEF DESCRIPTION OF THE DRAWINGS

The foregoing and other features of the example embodiments of the present invention will be apparent from the more particular description of non-limiting embodiments, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a diagram illustrating an example of an informational data providing environment according to one embodiment.

FIG. 2 is a block diagram illustrating a configuration of a voice informational data providing system according to one exemplary embodiment.

FIG. 3 is a flowchart illustrating a voice informational data providing method according to one embodiment.

FIG. 4 is a flowchart illustrating a process of determining cost according to providing voice informational data according to one embodiment.

FIG. 5 is a flowchart illustrating a process of determining the ranking of voice informational data according to one embodiment.

FIG. 6 is a table showing an example of providing the ranking of voice informational data.

FIG. 7 is a flowchart illustrating a process of targeting voice informational data according to one embodiment.

FIG. 8 is a flowchart illustrating a process of controlling the transmission of voice informational data according to one embodiment.

FIG. 9 is a flowchart illustrating a process of exposing voice informational data of a publisher according to one embodiment.

FIG. 10 is a block diagram illustrating an example of a configuration of a computer system according to one embodiment.

### DETAILED DESCRIPTION

Example embodiments of the present invention will now be described more fully with reference to the accompanying drawings, in which some example embodiments are shown.

Example embodiments may, however, be embodied in many different forms and should not be construed as being limited to the embodiments set forth herein; rather, these example embodiments are provided so that this disclosure will be thorough and complete, and will fully convey the scope of the example embodiments to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms “first”, “second”, etc. may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein

Hereinafter, example embodiments will be described with reference to the accompanying drawings.

The example embodiments of the present invention relate to a content providing model that provides voice informational data, for example, voice content, and more particularly, to a content providing model that provides voice informational data separate from contents provided in a service field of providing voice-based contents over a wired/wireless network, for example, a multimedia streaming service.

In the recent times, a user using a mobile terminal, for example, a smartphone or a tablet, may simultaneously perform an action of viewing a screen and an action of listening to broadcasting or music. Through such actions, the user generally consumes content associated with voice information. Voice content refers to a portion to be consumed by the user separate from visual content, for example, an image and a text displayed on a screen, and corresponds to additional traffic of an existing image or text.

The example embodiments are to construct a platform with additional content that is produced in a voice form and includes voice informational data, and to provide an environment capable of providing a user with additional content that includes the voice informational data during a process of consuming, by the user, voice content.

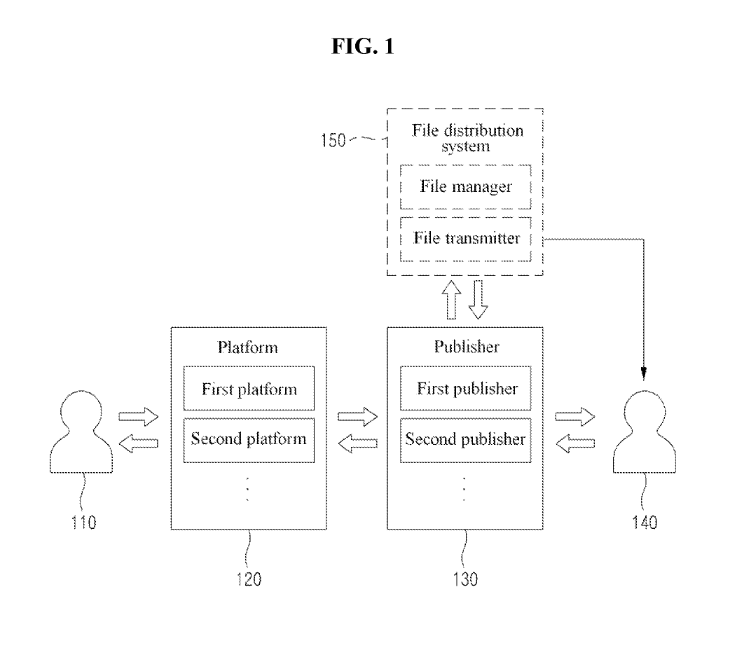

FIG. 1 is a diagram illustrating an informational data providing environment according to one exemplary embodiment. FIG. 1 illustrates a content provider 110, a platform 120, a publisher 130, and a user 140. The content provider 110 and the user 140 may indicate terminals, for example, a personal computer (PC) or a smartphone, used by the content provider 110 and the user 140. In FIG. 1, indicators with arrowheads indicate that data may be transmitted and received among the terminal used by the content provider 110, the platform 120, the publisher 130, and the terminal used by the user 140 over a wired/wireless network.

The platform 120 may refer to a system that performs bidding for content provided as informational data of the content provider 110, matching between content and a targeting element for a user to which the content is to be provided, sorting contents or content providers 110, providing content to the publisher 130, charging the content provider 110 for exposing content, and the like.

In the present specification, the term “publisher” may be interchangeably used with the term “site”. However, description using the term “site” is not to be constructed as excluding a probability that the example embodiments may be carried out in an environment beyond a general PC website connection such as an application screen executed on a mobile terminal. The term “site” may be compatibly used with a “publishing site” or a “publisher”. That is, each site may correspond to an individual publisher, for example, a first publisher and a second publisher included in the publisher 130. Each of the individual publishers may be configured as one or more publisher servers. Here, the term “site” may include any type of websites through which content may be exposed. The site may be provided to the user 140 over a wired or wireless network. The site may indicate a single webpage configuring a website.

Also, in the present specification, “exposing” content may be interpreted to include providing promotional content associated with the content provider 110 to a visitor of a corresponding site in a voice form through the publisher 130.

The publisher 130 may receive contents to be provided through the site of the publisher 130 from the platform 120, and may provide the received contents to the user 140. For example, the publisher 130 may receive, from the platform 120, voice-type additional content suitable for a content consumption environment of the user 140 during a process of consuming, by the user 140, voice content, and may provide the received additional content to the user 140.

As described above, the publisher 130 may expose a path via which the user 140 directly receives content. For example, in a general online environment, contents may be exposed through a website/mobile site. Each of a plurality of individual platforms, for example, a first platform and a second platform, included in the platform 120 may expose content through at least one individual publisher among a plurality of publishers, for example, the first publisher and the second publisher, included in the publisher 130. Here, each of the individual platforms may be configured as one or more platform servers.

In FIG. 1, a file distribution system 150 may be selectively used as needed. For example, when the user 140 uses a mobile terminal, the file distribution system 150 may provide the user 140 with a file for installing an application associated with the publisher 130 in the mobile terminal. To this end, the file distribution system 150 may include a file manager configured to store and maintain the file and a file transmitter configured to transmit the file to the mobile terminal in response to a request of the mobile terminal. The application may be installed in the mobile terminal using the transmitted file. The application may control the mobile terminal to perform operations of providing voice informational data according to some example embodiments.

A voice informational data providing system according to an embodiment of the present invention may be a computer system that configures the aforementioned platform.

One example embodiment may employ the informational data providing environment of FIG. 1. Here, a provider of the platform 120 may design the platform 120 so that the content provider 110 may select, for example, basic cost per traffic about voice informational data that is content of the content provider 110, a running time, that is, playback time of a voice corresponding to the voice informational data, and a targeting element, such as a region, time, weather, and a category, with respect to a user to which the voice informational data is to be provided. Accordingly, the content provider 110 may register the content of the content provider 110 to the platform 120 by uploading voice informational data content to the platform 120 and by making a payment for or bidding cost according to a playback time and a targeting element.

A service provider that provides a voice content based service, as the publisher 130, may receive voice informational data through the platform 120, may provide the voice informational data to the user 140 as additional content during a process of consuming, by the user 140, the voice content, and may share revenues according to providing the voice informational data with the provider of the platform 120. For example, the publisher 130 may indicate a site or an application of a provider that provides a multimedia streaming service, and may include all of media that provide voice contents to a service target and generate revenues through the voice contents. An example of the publisher 130 may include a radio broadcasting station. The publisher 130 may perform publishing activities in various environments for servicing voice contents, for example, podcast, a music application, and a radio application.

A program associated with the publisher 130 may be installed in a terminal used by the user 140. For example, a program may be installed in the terminal of the user 140 in a form of an application or a plug-in form, and may control the terminal of the user 140 or a web browser of the terminal of the user 140 to output information provided from the publisher 130.

Hereinafter, a voice informational data providing system and a voice informational data providing method according to an embodiment of the present will be described.

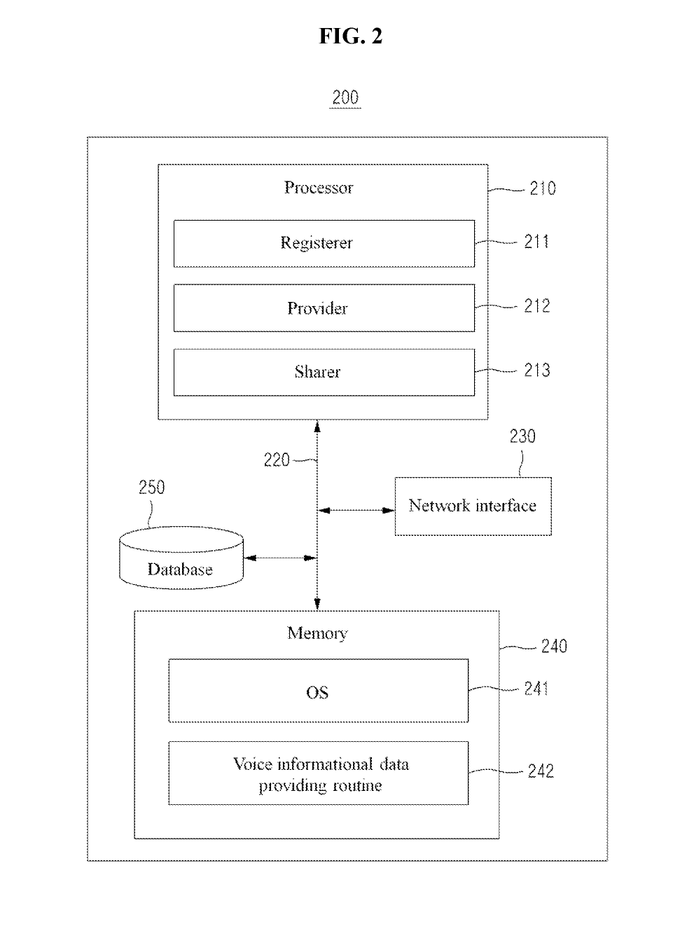

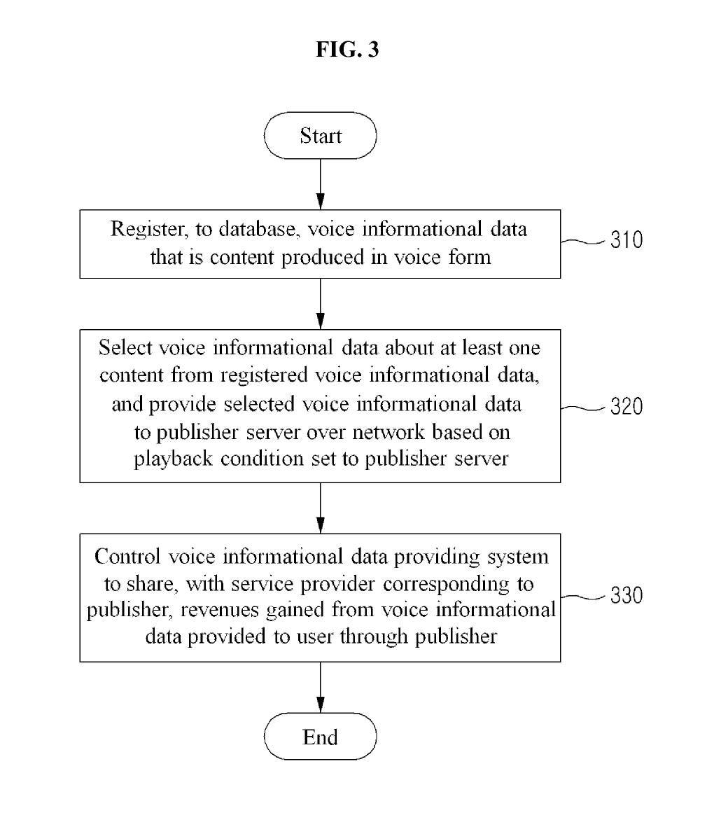

FIG. 2 is a block diagram illustrating a configuration of a voice informational data providing system according to one example embodiment, and FIG. 3 is a flowchart illustrating a voice informational data providing method according to an example embodiment.

Referring to FIG. 2, a voice informational data providing system 200 corresponds to each of the platforms (first platform, second platform, etc.) in the platform 120 of FIG. 1. The voice informational data providing system 200 includes a processor 210, a bus 220, a network interface 230, a memory 240, and a database 250. The memory 240 may include an operating system (OS) 241 and a voice informational data providing routine 242. The processor 210 includes a registerer 211, a provider 212, and a sharer 213. According to other example embodiments, the voice informational data providing system 200 may include more constituent elements than the number of constituent elements of FIG. 2.

The memory 240 may include a permanent mass storage device, such as a random access memory (RAM), a read only memory (ROM), and a disc drive, as a computer-readable storage medium. Also, program codes for the OS 241 and the voice informational data providing routine 242, and the like, may be stored in the memory 240. Such software constituent elements may be loaded from another computer-readable storage medium separate from the memory 240 using a drive mechanism (not shown). The other computer-readable storage medium may include, for example, a floppy drive, a disc, a tape, a DVD/CD-ROM drive, and a memory card. Software constituent elements may be loaded to the memory 240 through the network interface 230 instead of using the computer-readable storage medium. According to other example embodiments, software constituent elements may be loaded to the memory 240 through the network interface 230 instead of computer-readable storage media.

The bus 220 enables communication and data transmission between the constituent elements of the voice informational data providing system 200. The bus 220 may be configured using a high-speed serial bus, a parallel bus, a storage area network (SAN), and/or another appropriate communication technology.

The network interface 230 may be a computer hardware constituent element for connecting the voice informational data providing system 200 to the computer network. The network interface 230 may connect the voice informational data providing system 200 to the computer network through a wireless or wired connection.

The database 250 serves to store and maintain voice informational data content registered by a content provider, for example, the content provider 110 of FIG. 1. Although FIG. 2 illustrates that the database 250 is included in the voice informational data providing system 200, it is only an example and the entire database or a portion of the database 250 may be present as an external database constructed in another system.

The processor 210 may be configured to process computer-readable instructions of a computer program by performing basic calculations, logic, and input/output operations of the voice informational data providing system 200. The computer-readable instructions may be provided from the memory 240 or the network interface 230 to the processor 210 through the bus 220. The registerer 211, the provider 212, and the sharer 213 included in the processor 210 are configured to perform operations 310 through 330 of FIG. 3 by executing program codes loaded to the memory 240. The program codes may be loaded from a program file to a recording device such as the memory 240. The registerer 211, the provider 212, and the sharer 213 included in the processor 210 are representation of different functions performed by the processor 210. For example, the processor 210 is configured to execute operation 310 of the program codes as the registerer 211.

In operation 310, the registerer 211 registers voice informational data that is content produced in a voice form, into a database, for example, the database 250 of FIG. 2. For example, the voice informational data providing system 200 provides a content registration environment in which a content provider 110 may upload voice informational data as content and may register basic information associated with the voice informational data. In detail, the voice informational data providing system 200 provides the content provider 110 with a tool for managing voice informational data, and may receive, from the content provider 110, an input of or a selection on basic information that includes cost according to providing voice informational data, for example, cost per traffic of the voice informational data, a playback time of the voice informational data, and a targeting element with respect to a user to which the voice informational data is to be provided. Accordingly, the content provider 110 may make a payment or bidding based on the playback time and the targeting element, and the voice informational data received in the content registration environment may be registered to a corresponding platform through the registerer 211.

In operation 320, the provider 212 selects voice informational data about at least one content from the registered voice informational data, and provides the selected voice informational data to a publisher server over a network based on a playback condition set to the publisher server. For example, the voice informational data providing system 200 may select voice informational data that matches a playback condition of a publisher 130 and a content consumption environment of the user from the voice informational data registered to the platform 120, and may provide the selected voice informational data to the user through the corresponding publisher 130. The publisher 130 may receive voice informational data through the platform 120 without directly collecting voice informational data to be provided as additional content. In this instance, the publisher 130 may set a playback time section of the selected voice informational data as a playback condition for receiving the voice informational data from the platform 120. Accordingly, the provider 212 may automatically transmit, to the publisher 130, the voice informational data that matches the playback condition of the publisher 130. Here, the provider 212 may collect information associated with the user, may target voice informational data suitable for the user by applying various targeting methods, and may transmit the targeted voice informational data to the user 140. In addition, to increase a transmission efficiency of voice informational data and to reduce the user's fatigue coming from consuming the additional data, the provider 212 may transmit voice informational data that matches the playback condition of the publisher 130, based on an actual content consumption environment of the user 140. For example, the provider 212 may determine whether to transmit voice informational data based on whether it is an environment in which the user 140 is capable of substantially consuming the voice informational data and whether the same voice informational data is repeatedly being played back.

In operation 330, the sharer 213 controls the voice informational data providing system 200 to share, with a service provider corresponding to the publisher 130, revenues gained from the voice informational data provided to the user 140 through the publisher 130. That is, the voice informational data of the content provider 110 is transmitted to the publisher 130 based on the playback condition of the publisher 130 and the content consumption environment of the user 140. In this instance, desired (or alternatively predetermined) revenues may occur per transmission of voice informational data or per transmission traffic of voice informational data. The sharer 213 may control the voice informational data providing system 200 so that a desired (or alternatively predetermined) portion of the revenues may be distributed to the service provider. For example, the voice informational data providing system 200 may calculate an amount of revenues to be provided to the service provider through the sharer 213.

Accordingly, a content providing model according to some example embodiments may be configured in a structure in which a publisher 130 having traffic receives voice informational data as additional content by selecting a platform, and revenues according to exposing voice informational data is shared between the platform 120 and the publisher 130.

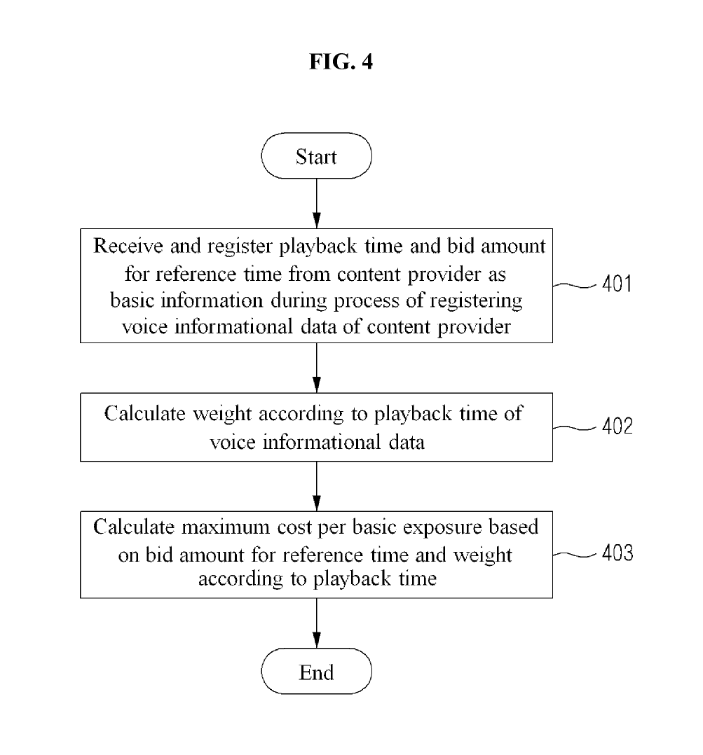

FIG. 4 is a flowchart illustrating a process of determining cost according to exposing voice informational data, for example, a playback of a voice included in the voice informational data, according to one example embodiment. Operations 401 through 403 included in the cost determining process of FIG. 4 are performed by the registerer 211 and the sharer 213 of FIG. 2.

For example, cost according to providing voice informational data to a user 140 through a medium provided from a publisher 130 may be determined through bidding. The determined cost may be charged to a content provider 110 in response to providing the voice informational data. To this end, the content provider 110 may submit an amount that the user is capable of paying per one-time playback of a reference time, for example, 15 seconds, and the cost according to providing the voice informational data may be calculated by multiplying the amount by a weight according to an actual playback time.

In detail, in operation 401, the registerer 211 may receive and register a playback time and a bid amount for a reference time from a content provider 110 as basic information during a process of registering voice informational data of the content provider 110. Here, the reference time may indicate a unit time for playing back a voice corresponding to the voice informational data and the content provider 110 may submit a maximum Willingness to Pay (WTP) for the reference time as the bid amount.

In operation 402, the sharer 213 may calculate a weight according to a playback time of voice informational data. For example, the weight according to the playback time of the voice informational data may be defined as [weight=playback time of voice informational data/reference time].

In operation 403, the sharer 213 may calculate maximum cost per basic exposure based on the bid amount for the reference time and the weight according to the playback time. For example, the maximum cost per basic exposure of voice informational data may be defined as [cost=bid amount for reference time×weight according to playback time].

As described above, the sharer 213 may calculate cost per one-time exposure of the voice informational data based on the bid amount for the reference time and the weight according to the actual playback time. The actual charge may vary based on the quality of each voice informational data. For example, a desired (or alternatively predetermined) amount of discount may be applied to the calculated cost based on a quality index (QI) that is calculated for each voice informational data.

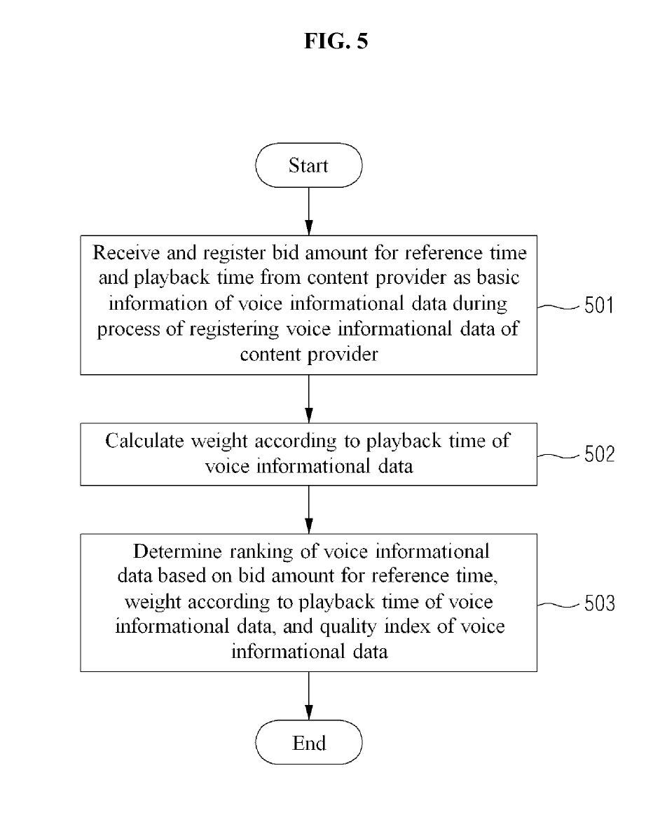

FIG. 5 is a flowchart illustrating a process of determining a ranking of voice informational data according to an example embodiment. Operations 501 through 503 included in the process of determining the ranking of voice informational data of FIG. 5 are performed by the registerer 211 and the provider 212 of FIG. 2.

Exposing of voice informational data may be determined based on a ranking index (RI) and the ranking index may be determined as follows.

In operation 501, the registerer 211 receives and registers a bid amount for a reference time and a playback time from a content provider 110 as basic information of voice informational data during a process of registering voice informational data of the content provider 110.

In operation 502, the provider 212 calculates a weight according to a playback time of voice informational data. For example, the weight according to the playback time of voice informational data may be defined as [weight=playback time of voice informational data/reference time].

In operation 503, the provider 212 determines the ranking of the voice informational data based on the bid amount for the reference time, the weight according to the playback time of the voice informational data, and a quality index of the voice informational data. Here, the quality index may indicate a predicted user satisfaction index for each targeting element of the voice informational data. For example, the ranking index may be defined as [ranking index (RI)=bid amount for reference time×weight according to playback time of voice informational data×quality index of voice informational data]. Here, the predicted user satisfaction index may be calculated using a statistical method based on empirical data in which user satisfaction is measured for each targeting element in association with voice informational data provided to users.

Further, the provider 212 may apply a frequency capability (cap) to voice informational data based on a user's fatigue coming from consuming the voice informational data provided as additional content. For example, the provider 212 may control transmission counts of the voice informational data to be exposed based on an hour unit or a day unit, to prevent the same voice informational data from being repeatedly exposed to the user and thereby decreasing the user's fatigue for the voice informational data.

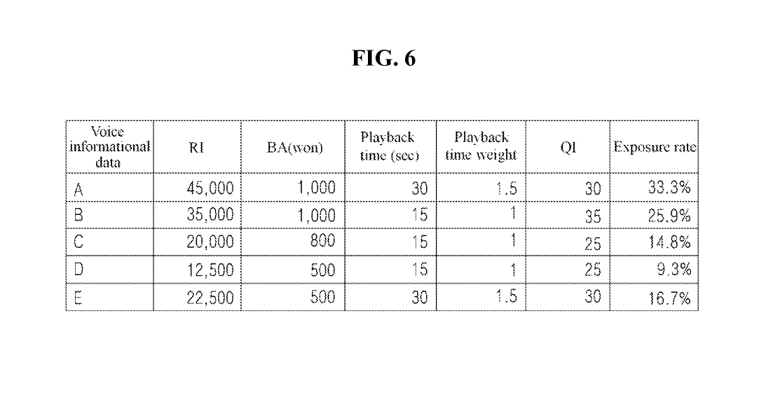

FIG. 6 is a table showing an example of providing ranking of voice informational data.

Here, it is assumed that an amount of time in which voice informational data is actually playable in a time section, for example, a playable time section of voice informational data, selected by the publisher 130 and a waiting list of voice informational data is shown in the table of FIG. 6. In this example, the voice informational data may be played back in order of voice informational data A (30 seconds), voice informational data B (15 seconds), and voice informational data C (15 seconds) (60 seconds (1 minute)=30 seconds+15 seconds+15 seconds). Although voice informational data E (30 seconds) has a relatively high playback priority according to a ranking index (RI), voice informational data C (15 seconds) is selected due to a limited playback time.

The provider 212 may determine an exposure rate of voice informational data based on the ranking index of the voice informational data. For example, the exposure rate may be defined as [exposure rate=ranking index of each voice informational data/total ranking index of voice informational data in a waiting list to be provided].

When a playback time corresponding to a time section of the publisher 130 is sufficient, an exposure opportunity according to an exposure rate of each voice informational data may be obtained. Here, voice informational data corresponding to a relatively high ranking index may be repeatedly exposed.

Accordingly, voice informational data may be exposed using a method of determining an actual playback priority of voice informational data as an exposure rate based on a ranking index in which a bid amount submitted from a content provider and a target element are combined.

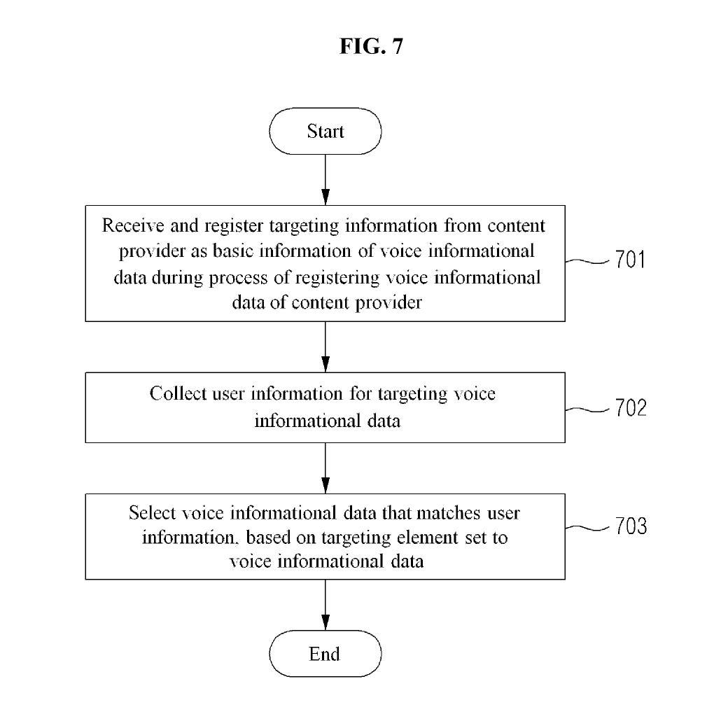

FIG. 7 is a flowchart illustrating a process of targeting voice informational data according to an example embodiment. Operations 701 through 703 included in the voice informational data targeting process of FIG. 7 are performed by the registerer 211 and the provider 212 of FIG. 2.

Voice informational data according to the example embodiments may be designed to be transmitted to a terminal, for example, a PC or a smartphone used by a user, based on a network, and may be provided to users targeted using a variety of methods.

In operation 701, the registerer 211 receives targeting information from a content provider 110 as basic information of voice informational data during a process of registering voice informational data of the content provider, and registers the received targeting information. A principal targeting element may include a region, a gender, weather, a matter of interest for each individual or cluster, and a behavior, for example, an action history of a user 140. The content provider 110 may register voice informational data and information for targeting the voice informational data. For example, the content provider may set a promotion area, for example, the whole country and regions around a Gangnam station, in which the content provider 110 is to promote voice informational data. As another example, the content provider 110 may set a desired time zone, for example, an attendance time, a closing time, and 9:00 PM to 2:00 PM, in which voice informational data is to be played back. As another example, the content provider 110 may set a demo, for example, singles in their twenties, sales persons in their thirties, and females in their sixties, for which voice informational data is to be played back. As another example, the content provider 110 may set a type of a product being expressed by a voice information provider, and a category of the product, for example, a mobile application, a restaurant, and a travel product. As another example, the content provider 110 may set connection information, for example, a website address and a telephone number, of the content provider. As another example, the content provider 110 may set a list of applications in which voice informational data is to be played back as a targeting element of the voice informational data. For example, a list of applications may be set as a targeting element so that voice informational data may be transmitted only when a specific application, for example, podcast and a music application, is executed in the user terminal. Conversely, a list of applications may be set as an anti-targeting element so that voice informational data may not be transmitted when a video application is in execution at the user terminal, or when the user 140 is making a call.

In operation 702, the provider 212 collects user information for targeting voice informational data. For example, the provider 212 may identify a user 140 based on login information and cookies of a terminal used by the user and may collect an online action history, for example, a search log, an application execution history, and a push information history, of the user. As another example, the provider 212 may define a matter of interest, for example, a movie and a travel, of the user 140 or a group, for example, sales persons in their twenties and single males in their thirties, to which the user belongs. As another example, the provider 212 may verify a residential area or a current location of the user 140 based on a GPS value received at a terminal used by the user 140 and network connection information, for example, information about wireless fidelity (WiFi) and a base station.

In operation 703, the provider 212 selects voice informational data that matches user information, based on a targeting element set to the voice informational data. Here, the provider 212 may determine voice informational data most suitable for the user 140 from voice informational data on a platform, based on the user information collected in operation 702, by applying a variety of targeting methods, and may transmit the determined voice informational data in real time. For example, when a female in her twenties is passing by a subway station around 8:00 A.M., the provider 212 may determine that the female is going to work and may control the voice informational data providing system 200 to transmit targeted voice informational data in an attendance time zone. As another example, when a male in his forties is quite away from a frequent visiting area, the provider 212 may determine that the male is on business or travel and may control the voice informational data providing system 200 to transmit voice informational data targeted to a corresponding area. As another example, when the user executes a shopping application in the morning, the provider 212 may determine that a matter of interest of the user for the day is shopping and may control the voice informational data providing system 200 to transmit voice informational data targeted to shopping in that afternoon. As another example, when the user makes a call to a hotel, the provider 212 may control the voice informational data providing system 200 to transmit voice informational data targeted to an area at which the hotel is located. In addition, when an action pattern of the user, for example, planning overseas travel, enjoying watching a movie, and frequently going skiing, is determined as a result of analyzing online actions, for example, a call log, a search log, and location information of the user, the provider 212 may control the voice informational data providing system 200 to transmit voice informational data targeted in association with a result of the determination.

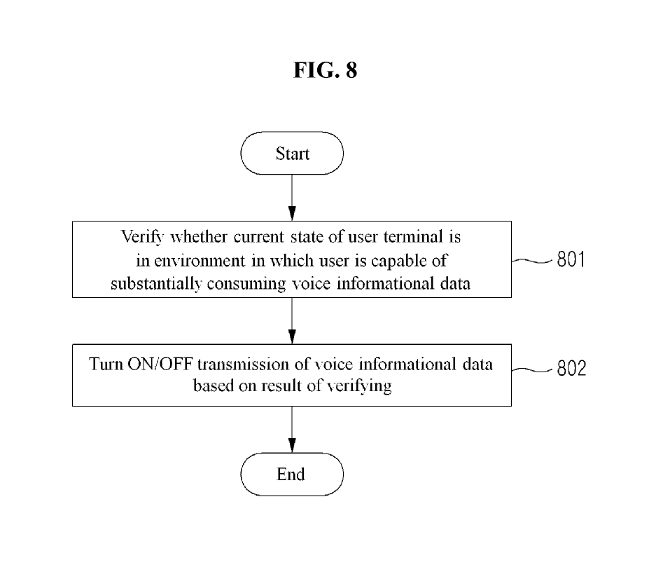

FIG. 8 is a flowchart illustrating a process of controlling transmission of voice informational data according to some example embodiments. Operations 801 and 802 included in the voice informational data transmission controlling process of FIG. 8 may be performed by the provider 212 of FIG. 2.

In operation 801, the provider 212 preferentially verifies whether the current state of a user terminal is in an environment in which a user 140 is capable of substantially consuming, for example, playing back voice informational data. For example, the provider 212 may determine whether an audio output device, for example, AUX and an earphone, is connected to the user terminal or whether a voice output is in execution through the audio output device. As another example, the provider 212 may verify an application that is in execution at the user terminal and may determine whether the application is a transmission target App of voice informational data that is a targeting element set by the content provider 110 or a blocking target App of voice informational data that is an anti-targeting element.

In operation 802, the provider 212 controls whether to transmit (ON/OFF) voice informational data based on the content consumption environment of the user terminal verified in operation 801. For example, when a voice output of the user terminal is determined to be currently in execution, the provider 212 may transmit voice informational data. Although the voice output of the user terminal is currently in execution, a video application may be executed and the user may be viewing a video. In this case, the provider 212 may determine that the transmission of voice informational data is impossible and may control the voice informational data not to be transmitted. Also, when the user 140 is making a call, the transmission of voice informational data may be blocked regardless of the voice output of the user terminal being currently in execution. Conversely, when a specific application set by the content provider 110 is in execution at the user terminal, the provider 212 may transmit voice informational data. For example, when the voice output of the user terminal is currently in execution and podcast or a music application that is a transmission target App of voice informational data, the transmission of voice informational data may be limitedly allowed.

Although the content consumption environment of the user terminal is in a state in which the transmission of voice informational data is allowed, the same voice informational data may be continuously played back. In this case, the user may perceive a significant fatigue for the voice informational data. Accordingly, the provider 212 may control an exposure frequency for each voice informational data. For example, the provider 212 may apply various exposure limits for each voice informational data, such that specific voice informational data may be played back at the frequency of twice or less a day or once or less per month. Similarly, user information may be collected and analyzed for targeting of voice informational data. A search log or an action pattern of the user is a temporary matter of interest and thus, may be susceptible to be volatile information. Thus, an expiry time may be applied to corresponding information. In view that the transmission of voice informational data may become meaningless without the interest of the user, voice informational data that matches a search log may be defined to be transmitted during a period of time from a point in time at which the search log has occurred. Here, the expiry time for volatile information may be set to be different based on an information characteristic. The search log may be set to be different based on a keyword.

According to example embodiments, it is possible to enhance the transmission efficiency of voice informational data, and to minimize user fatigue coming from consuming voice informational data by transmitting the voice informational data in an environment in which the user is capable of substantially consuming the voice informational data, and by controlling the same voice informational data not to be repeatedly played back.

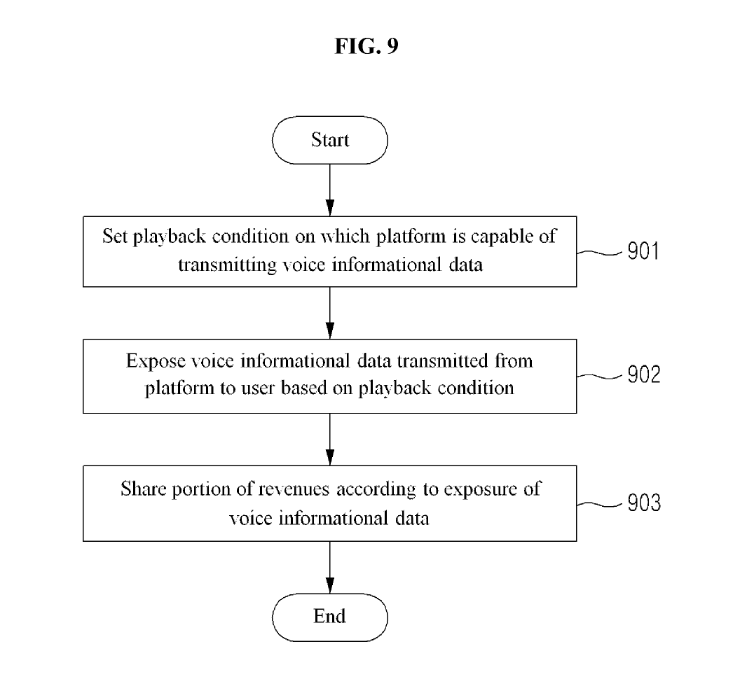

FIG. 9 is a flowchart illustrating a process of exposing voice informational data of a publisher 130 according to one embodiment.

In operation 901, the publisher 130 sets a playback condition on which a platform 120 is capable of transmitting voice informational data. The publisher 130 may receive the voice informational data through the platform 120, and a time section in which the voice informational data is playable may be set as the playback condition for receiving the voice informational data from the platform. For example, to expose voice informational data during a content consumption process of the user, the publisher 130 may set a location at which the voice informational data is to be played back, that is, a location, for example, a time section, at which the voice informational data is to be played back during a service providing time, and a playback time, for example, 1 minute, of the voice informational data. Here, the publisher 130 may set a targeting element, for example, an area, a gender, and weather, as the playback condition. For example, the publisher 130 may designate a category to be played back or a category to be excluded in association with voice informational data.

In operation 902, the publisher 130 exposes voice informational data transmitted from the platform 120 to the user based on the playback condition. That is, the publisher 130 may automatically receive voice informational data from the platform 120 in a determined time section, and may transmit the voice informational data to a terminal of the user 140 over a network that provides a service. In this case, a voice corresponding to the voice informational data may be output from the terminal of the user 140. The publisher 130 may provide the user 140 with the selected voice informational data by selectively receiving only voice informational data of a desired (or alternatively predetermined) category or excluding the voice informational data from a transmission target based on a service characteristic. For example, when the publisher 130 provides a music broadcasting service, the publisher may exclude voice informational data associated with a plastic surgery from a target to be exposed.

In operation 903, the publisher 130 may share a portion of revenues according to exposure of voice informational data with a platform provider with respect to the voice informational data exposed to the user 140 while providing a service. That is, when voice informational data is played back normally based on the playback condition set by the publisher 130, revenues may be generated per exposure of the voice informational data. A portion of the revenues may be distributed to the platform provider.

Further, the publisher 130 may provide a reward to a user 140 that consumes the voice informational data. For example, the publisher 130 may expand and secure a consumption target of voice informational data by providing a variety of benefits, for example, a free voucher, a coupon, and mileage, to the user 140 of the terminal from which the voice informational data is output.

Accordingly, the publisher 130 such as an Internet radio broadcast service may automatically receive, from the platform 120, voice informational data suitable for a playback condition and may expose the received voice informational data to the user 140 by setting the playback condition, without directly collecting additional data such as the voice informational data. Further, in view of a publisher server, there is no need to perform processing, such as collecting, registering, and selecting voice informational data. Thus, it is possible to reduce the data usage amount and to decrease a calculation amount in providing voice informational data.

Although a computer system corresponding to a publisher, for example, a service provider is omitted in the drawings, the computer system may basically include a processor, a bus, a network interface, and a memory. The memory may include an OS and a service providing routine. The processor may include a constituent element for connection with a voice informational data providing system 200 that is a platform, based on the description made with reference to FIGS. 1 through 8.

The voice informational data providing method may include a reduced number of operations or additional operations based on the description made above with reference to FIGS. 1 through 9. Also, two or more operations may be combined and orders or locations of operations may be changed.

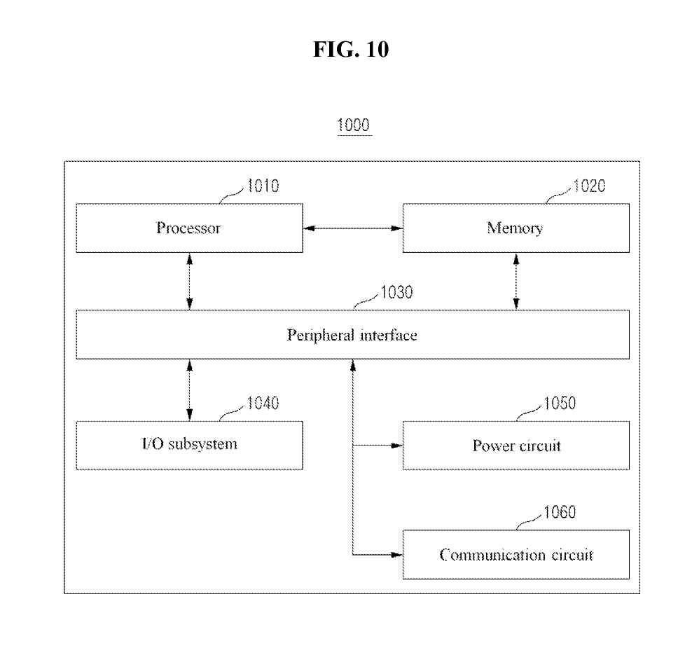

FIG. 10 is a block diagram illustrating an example of a configuration of a computer system according to one example embodiment. Referring to FIG. 10, the computer system 1000 may include at least one processor 1010, a memory 1020, a peripheral interface 1030, an input/output (I/O) subsystem 1040, a power circuit 1050, and a communication circuit 1060. Here, the computer system 1000 may correspond to the terminal of the user 140.

The memory 1020 may include, for example, a high-speed random access memory (HSRAM), a magnetic disk, a static random access memory (SRAM), a dynamic RAM (DRAM), read only memory (ROM), a flash memory, and a non-volatile memory. The memory 1020 may include a software module, an instruction set, or a variety of data required for an operation of the computer system 1000. Here, an access from another component such as the processor 1010 and the peripheral interface 1030 to the memory 1020 may be controlled by the processor 1010.

The peripheral interface 1030 may couple an input device and/or output device of the computer system 1000 with the processor 1010 and the memory 1020. The processor 1010 may perform a variety of functions for the computer system 1000 and process data by executing the software module or the instruction set stored in the memory 1020.

The I/O subsystem 1040 may couple various I/O peripheral devices with the peripheral interface 1030. For example, the I/O subsystem 1040 may include a controller for coupling the peripheral interface 1030 and a peripheral device such as a monitor, a keyboard, a mouse, a printer, and a touch screen or a sensor depending on necessity. The I/O peripheral devices may be coupled with the peripheral interface 1030 without using the I/O subsystem 1040.

The power circuit 1050 may supply power to all of or a portion of components of the terminal. For example, the power circuit 1050 may include a power management system, at least one power source such as a battery and alternating circuit (AC), a charge system, a power failure detection circuit, a power converter or inverter, a power status indicator, or other components for creating, managing and distributing power.

The communication circuit 1060 enables communication with another computer system using at least one external port. Alternatively, as described above, the communication circuit 1060 may enable communication with another computer system by including a radio frequency (RF) circuit and thereby transmitting and receiving an RF signal known as an electromagnetic signal.

The example embodiment of FIG. 10 is only an example of the computer system 1000. The computer system 1000 may have a configuration or an arrangement for omitting a portion of the components illustrated in FIG. 10, further including components not illustrated in FIG. 10, or coupling two or more components. For example, a computer system for a communication terminal of a mobile environment may further include a touch screen, a sensor, and the like, in addition to the components of FIG. 10. A circuit for RF communication using a variety of communication methods, for example, wireless fidelity (Wi-Fi), 3rd generation (3G), long term evolution (LTE), Bluetooth, near field communication (NFC), and ZigBee, may be included in the communication circuit 1060. Components includable in the computer system 1000 may be configured as hardware that includes an integrated circuit specified for at least one signal processing or application, software, or a combination of hardware and software.

The methods according to the example embodiments may be configured in a program instruction form executable through various computer systems and thereby recorded in non-transitory computer-readable media.

As described above, according to some example embodiments, it is possible to apply voice informational data to the overall network-based service through a new type of content providing model by constructing a platform for content in which a voice is used as a material and by providing the voice informational data for voice content. Also, according to some example embodiments, since a streaming service that provides voice-based contents provides voice type additional content, it is possible to further activate a voice content market that is distinguished from existing services. Also, according to some example embodiments, it is possible to enhance the transmission efficiency of additional content, to decrease a user's fatigue coming from consuming the additional content, and to increase the reliability between the user and a provider of the additional content by targeting and controlling the transmission of voice type additional content based on the content consumption environment of the user.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device(s) configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device(s) may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, and/or computer storage medium or device. The software also may be distributed over network coupled computer systems so that the software is stored and executed in a distributed fashion. The software and data may be stored by one or more computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. A voice informational data providing method executed in a computer to provide voice informational data over a network, the method comprising:
registering in a database, by a processor of the computer, voice informational data that is content produced in a voice form; and
selecting, by the processor, voice informational data about at least one piece of content from the registered voice informational data, and providing the selected voice informational data to a publisher server over the network based on a playback condition set to the publisher server.

2. The method of claim 1, wherein the publisher server is configured to provide a medium that provides a network-based service to a terminal of a user, and
the providing to the publisher server comprises providing the selected voice informational data to the terminal of the user through the medium.

3. The method of claim 1, wherein the providing to the publisher server comprises providing the selected voice informational data based on the playback condition in response to the publisher server selecting at least one playback condition from among a playback time section of the selected voice informational data, a playback time of the selected voice informational data, and a targeting element about a user to receive the selected voice informational data.

4. The method of claim 1, wherein the providing to the publisher server comprises:
determining a ranking index for each registered voice informational data based on a bid amount for a playback time and a basic playback time of the registered voice informational data; and
determining voice informational data to be provided to the publisher server from the registered voice informational data based on the ranking index.

5. The method of claim 4, wherein the determining of the ranking index comprises applying a weight according to the playback time to the bid amount.

6. The method of claim 2, wherein the providing to the publisher server comprises:
collecting user information for a target in association with the user; and
selecting voice informational data of content that matches the collected user information based on a targeting element set to the voice informational data.

7. The method of claim 2, wherein the providing to the publisher server comprises:
verifying an output environment associated with the selected voice informational data in a terminal used by the user; and
controlling whether to transmit the selected voice informational data to the publisher server based on the output environment.

8. The method of claim 7, wherein the verifying of the output environment comprises verifying at least one of a connection between the terminal and an audio output device and an execution of an application set to the voice informational data at the terminal.

9. The method of claim 7, wherein whether to transmit the selected voice informational data to the publisher server is controlled based on an exposure frequency capacity set to the selected voice informational data.

10. The method of claim 1, further comprising:
calculating cost based on an amount of time in which the selected voice informational data is played back at a terminal of the user through a medium provided from the publisher server.

11. The method of claim 10, wherein the calculating of the cost comprises applying a weight according to the amount of time to a bid amount for a basic playback time of the selected voice informational data.

12. The method of claim 1, wherein revenues gained by playing back the selected voice informational data at a terminal of the user through the publisher server is shared with a publisher that provides the publisher server.

13. A voice informational data exposure method configured as a computer to expose voice informational data over a network, the method comprising:
setting, by a processor of the computer with respect to a network-based service that is provided to a user, at least one playback condition among a playback time section of voice informational data that is content produced in a voice form, a playback time of the voice informational data, and a targeting element about the user to receive the voice informational data; and
receiving, by the processor, voice informational data about at least one piece of content from voice informational data registered to a platform server from the platform server over the network based on the playback condition, and providing the received voice informational data to a terminal of the user.

14. A voice informational data providing system for providing voice informational data over a network, the system comprising:
at least one processor,
wherein the at least one processor comprises:
a registerer configured to register voice informational data that is content produced in a voice form; and
a provider configured to select voice informational data about at least one piece of content from the registered voice informational data, and to provide the selected voice informational data to a publisher server over the network based on a playback condition set to the publisher server.

15. The system of claim 14, wherein the publisher server is configured to provide a medium that provides a network-based service to a terminal of the user, and
the provider is further configured to provide the selected voice informational data to the terminal of the user through the medium.

16. The system of claim 14, wherein the provider is further configured to provide the selected voice informational data based on the playback condition in response to the publisher server selecting at least one playback condition from among a playback time section of the selected voice informational data, a playback time of the selected voice informational data, and a targeting element about a user to receive the selected voice informational data.

17. The system of claim 14, wherein the provider is further configured to determine a ranking index for each registered voice informational data based on a bid amount for a playback time and a basic playback time of the registered voice informational data, and to determine voice informational data to be provided to the publisher server from the registered voice informational data based on the ranking index.

18. The system of claim 15, wherein the provider is further configured to verify an output environment associated with the selected voice informational data in a terminal used by the user, and to control whether to transmit the selected voice informational data to the publisher server based on the output environment.

19. The system of claim 14, wherein revenues gained by playing back the selected voice informational data at a terminal of the user through the publisher server is shared with a publisher that provides the publisher server.

20. The system of claim 19, wherein the revenues is calculated based on an amount of time in which the selected voice informational data is played back at the terminal of the user through the medium provided from the publisher server and a bid amount for a basic playback time.
